(19) United States
(12) Patent Application Publication
(10) Pub. No.: US 2009/0121634 A1
(43) Pub. Date: May 14, 2009

(54) Electrode for a Discharge Lamp and a Method for Producing Such an Electrode

(75) Inventors: Rainer Koger, Berlin (DE); Markus Kolodziejczyk, Berlin (DE); Lars Menzel, Berlin (DE); Klaus Stedele, Obermuhlhausen (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: OSRAM Gesellschaft mit beschrankter Haftung, Munchen (DE)

(21) Appl. No.: 12/226,646

(22) PCT Filed: May 14, 2007
(86) PCT No.: PCT/EP2007/054630

§ 371 Date: Oct. 24, 2008

(30) Foreign Application Priority Data
May 22, 2006 (DE) 10 2006 023 970.9

(51) Int. Cl. H01J 61/073; H01J 1/02; H01J 9/02

(52) U.S. Cl. 313/631; 313/326; 445/46

(57) ABSTRACT

The invention relates to an electrode for a discharge lamp (I) with a cylindrical shaft (12) and a tip (11) which adjoins the cylindrical shaft (12), wherein a first material region (13) forming a core is formed in the longitudinal direction (A) of the electrode (1), and the core is surrounded, at least in regions, by a second material region (14) forming a casing. The invention also relates to a discharge lamp having such an electrode and to a method for producing an electrode for a discharge lamp.

### TECHNICAL FIELD

The invention relates to an electrode for a discharge lamp with a cylindrical shaft and a tip adjoining the cylindrical shaft. Furthermore, the invention relates to a method for producing such an electrode for a discharge lamp and to a corresponding discharge lamp.

### PRIOR ART

The cathodes of DC high-pressure discharge lamps, such as, for example, HBO lamps (mercury vapor lamps) or XBO lamps (xenon lamps), generally consist of tungsten, which is doped with thorium oxide. The content of thorium oxide in this case is approximately 0.4 to approximately 2 percent by weight. Since thorium oxide is a radioactive substance, radioactivity can also be demonstrated in the case of thoriated tungsten electrodes. There are legal requirements regulating the handling of radioactive substances. If a critical activity is reached, different identification specifications and measures when handling these substances are required. The doping of cathodes with thorium oxide has the function of lowering the work function at the cathode tip, as a result of which a lower cathode tip temperature can be achieved during lamp operation. In association with this, the cathode burnback occurring is reduced in the course of the lamp life, which is noticeable to the user positively in a lower decrease in the utilized flux or the utilized radiated light.

An increase in the lamp power generally requires enlarged cathode dimensions in order to keep the temperature and, associated with this, the electrode burnback as low as possible. In the case of discharge lamps up to a power of approximately 5 kW, the entire cathode or the cathode head can be produced from thoriated material without the limit value of the activity being overshot. At powers of more than 8 kW, this is no longer possible.

A cathode known from the prior art is shown in FIG. 1. In the case of a cathode 1′, which would be above the critical limit in terms of total activity owing to its size and its thorium content, the activity is set by the use of two materials which are mechanically joined to one another, of which materials one is doped with thorium oxide. The cathode 1′ for this purpose comprises a front tip region 11′, which is manufactured from a thoriated material. This block 11′ is positioned onto a second region 12′, which is arranged behind in the longitudinal direction and is formed from a thorium-free material. The cathode 1′ shown in FIG. 1 is relatively complex in terms of its production. The two parts 11′ and 12′ of the cathode 1′ are joined to one another in a relatively complex manner, with, for example, soldering or a screw-connection being provided for this purpose. In addition to this relatively complex production and assembly, starting problems of the discharge lamp can occur in the case of a cathode 1′ with such a design. These starting problems can be caused by the fact that attachment of the arc in the region of the joint between these two parts 11′ and 12′ can occur, and not at the frontmost end of the tip region 11′, as required.

### DESCRIPTION OF THE INVENTION

The object of the present invention is therefore to provide an electrode for a discharge lamp and a method with which the electrode can be produced with less complexity and moreover the critical limits as regards the activity of the material of this electrode can be kept within the required range. Furthermore, it is also the object to provide a corresponding discharge lamp with such an electrode and to provide a production method for such a discharge lamp.

These objects are achieved by an electrode which has the features according to patent claim 1 and by a discharge lamp which has the features according to patent claim 10. Furthermore, the objects are also achieved by a method which has the features according to patent claim 16.

An electrode according to the invention for a discharge lamp comprises a cylindrical shaft and a tip adjoining this cylindrical shaft. A core is formed in the longitudinal direction of the electrode, at least regions of said core being surrounded by a jacket. The core is in this case formed by a first material region, the core being surrounded by a second material region forming the jacket, the material regions being different from one another in terms of their compositions. As a result of such structuring of the electrode, the production thereof can be simplified and in particular the region of the joint between the two material regions and therefore between the core and the jacket can be made possible with less complexity. Moreover, with such an electrode, the legal requirements as regards the limit of the critical activity of the materials and in particular of the first material region can also be adhered to to a sufficient extent.

Preferably, the core region extends over the entire length of the shaft and of the tip, as a result of which a core region, which passes through completely in the longitudinal direction of the electrode, is formed as the first material region. It can also be provided that the core and therefore the first material region only extend partially over the entire length of the electrode. The core is therefore arranged so as to be substantially completely embedded in the jacket.

Preferably, the core is only exposed at a front end of the tip over a predeterminable length. The first material region is therefore advantageously only exposed at this front end, in which the jacket and therefore the second material region do not extend over the entire length of the electrode. The operating conditions of the lamp and in particular the cathode tip temperature can thereby be reduced. Not least can the attachment of the arc thereby also be very focused locally and furthermore also kept in the desired region of the electrode.

In a particularly advantageous manner, the electrode and in particular the configuration of the material regions and in particular the joint between the first material region and the second material region is formed by a sintering process. A mechanical joint which is complex to install, such as is the case in the prior art for example by means of soldering or a screw-connection, is therefore no longer required with this electrode.

The first material region is preferably formed around the longitudinal axis of the electrode in the longitudinal direction thereof and is arranged centered in the electrode. This central arrangement of the rod-shaped core then allows for the configuration of a jacket uniformly surrounding the core, as a result of which a symmetrical design is possible in relation to the longitudinal axis. This also makes it possible for the function of the electrode to be positively influenced.

The first material region is advantageously formed from a tungsten material, which has a thorium content and is therefore doped in particular with thorium oxide. The tungsten material of the first material region can, however, also be doped with all other materials which are suitable as electrode materials. For example, doping of the tungsten material with lanthanum oxide or yttrium oxide or other known dopings and admixtures can also take place. The first material region can, however, also be formed from another material or another combination of materials.

The second material region is preferably formed from a tungsten material and is free from thorium.

The method also makes it possible to produce a homogeneously mixed material in the case of relatively large electrodes in the first material region.

An electrode, in particular a cathode, which is formed from a composite material, in particular a composite tungsten material, can be produced. This composite material preferably has a thoriated material region in its inner core near to the axis, while the jacket located thereon is designed to be free from thorium. This configuration makes it possible for an electrode to be provided which has a markedly lower radio-activity in comparison with an equally sized electrode made from completely thoriated tungsten. In the case of the proposed electrode according to the invention, no disadvantageous response in comparison with the electrode known from the prior art is demonstrated in terms of the burnback characteristics, either.

Furthermore, incorrect attachment of the arc at the joint, as is the case in the case of the cathode 1′ shown in FIG. 1, can also be prevented. A further advantage of this proposed composite electrode also consists in the fact that, in the course of the life, the occurrence of an incorrect arc attachment, for example at the cathode edge during restarting of the discharge lamp, is avoided. The reason for this can be considered to be that the arc preferably attaches at points with a lower work function and therefore preferably in thoriated material regions. Since, however, in the preferred configuration of the proposed electrode, the jacket is not thoriated, it is not possible for an arc to attach here either. Preferably, the ratio of the diameter of the core of the electrode to the diameter of the entire electrode is in the value range of between 0.1 and 0.7. Particularly preferable here is a value of approximately 0.4. Owing to these dimensions, an optimum in view of the size of the cathode and its optimum operating response and also the required legal specifications with respect to the critical activity can be achieved.

In an advantageous embodiment, the electrode has a diameter of greater than or equal to 12 mm, in particular greater than or equal to 15 mm.

A further aspect of the invention relates to a discharge lamp, in particular a high-pressure discharge lamp, which comprises an electrode according to the invention or an advantageous embodiment thereof. Preferably, the discharge lamp is designed in such a way that it has an electrical power of greater than or equal to 4 kW, in particular greater than or equal to 5 kW. The proposed electrode has proven to be particularly advantageous for discharge lamps which have even electrical powers of greater than 8 kW. As a result of the configuration of the electrode, the limit value of the activity can be adhered to even in the case of discharge lamps with such powers.

The discharge lamp can be in the form of a mercury vapor lamp or a xenon lamp. In a configuration as a mercury vapor lamp, the mercury concentration can preferably be greater than or equal to 8 mg/ccm, in particular greater than or equal to 10 mg/ccm. If the discharge lamp is in the form of a xenon lamp, a xenon coldfilling pressure is preferably greater than 6 bar, in particular greater than 8 bar.

In the case of a method according to the invention for producing an electrode for a discharge lamp, the electrode is designed to have a cylindrical shaft and a tip adjoining the cylindrical shaft. In the longitudinal direction of the electrode, a first material region forming a core is formed and a jacket surrounding at least regions of the core is formed, the jacket being formed by a second material region, which is different in terms of its composition than the first material region. With this method it is possible to provide an electrode which meets the legal requirements in terms of the critical activity of the materials of the electrode and can nevertheless be produced with little complexity. In particular, in this configuration the two material regions are advantageously produced by a sintering process, as a result of which the mechanical joints between the materials no longer need to be formed in at least one further separate, complex manufacturing step which is relatively imprecise in terms of assembly. As a result, a discharge lamp can also be produced which comprises an electrode with such a design, as a result of which discharge lamps with very high electrical powers also do not exceed the limit value of the activity of the materials of the electrode.

Advantageous configurations of the electrode according to the invention and of the discharge lamp according to the invention can be regarded as advantageous configurations of the method according to the invention for producing an electrode and as advantageous configurations for producing a discharge lamp with such an electrode.

### BRIEF DESCRIPTION OF THE DRAWINGS

An exemplary embodiment of the invention will be explained in more detail below with reference to schematic drawings, in which:

FIG. 1 shows a sectional illustration of a cathode known from the prior art;

FIG. 2 shows a sectional illustration through an electrode according to the invention; and

FIG. 3 shows a sectional illustration through a high-pressure discharge lamp according to the invention.

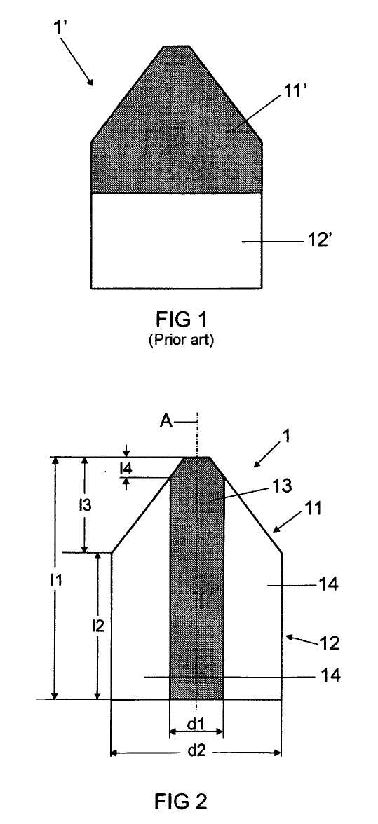

### PREFERRED EMBODIMENT OF THE INVENTION

FIG. 2 shows a schematic sectional illustration through an electrode in the form of a cathode 1. The cathode 1 comprises a tip 11, which is conical in the exemplary embodiment. The tip 11 becomes a cylindrical shaft 12. In the longitudinal direction of the cathode 1 and therefore in the direction of the longitudinal axis A, the cathode 1 has a length 11 which is the sum of the length 12 of the cylindrical shaft 12 and the length 13 of the tip 11. The configuration shown is merely by way of example and can be varied both in terms of the length ratios and in terms of the shapes.

As can be seen from the illustration in FIG. 2, the cathode 1 comprises a core 13, which is arranged centrally and centered in the cathode 1 in the exemplary embodiment and therefore is designed to be substantially rotationally symmetrical about the longitudinal axis A. In the exemplary embodiment, the core 13, which is formed by a first material region and is formed from a thorium-containing tungsten material in the exemplary embodiment, extends over the entire length of the cathode 1. The core 13 is doped with thorium oxide.

This core 13 is surrounded peripherally by a jacket 14, the jacket 14 being formed by a second material region, which is a thorium-free tungsten material in the exemplary embodiment.

In the embodiment shown, the core 13 extends beyond the jacket 14 at a front end of the tip 11. In this case, a raised region is formed which extends beyond the jacket 14 over the length 14. In this front region, the core 13 is therefore arranged so as to be exposed over this length 14 and is not surrounded by the jacket 14. Both the schematically illustrated lengths 11 to 14 and the respective ratios of these lengths 11 to 14 with respect to one another are merely by way of example and can likewise be different depending on the situation and depending on requirements. It can likewise be provided that the core 13 does not extend over the entire length 11 of the cathode 1, but, for example, extends only in the region of the tip 11 and, starting from the front end of the tip 11, for example, extends over the length 13. It can also be provided that this core 13, starting from the tip 11, also extends as far as into the cylindrical shaft 12.

In the exemplary embodiment, this core 13 is in the form of a pin and has a substantially equal diameter d1 over the length 11. Only in the front end of the tip 11 and therefore over the length 14 is this core 13 conical and therefore tapered. This pin-like configuration of the core 13 is not absolutely necessary and the diameter d1 and the shape of the core 13 can also be designed to be different. In particular, the diameter d1 can also be varied in the region of the shaft 12 and the region protruding into the tip 11.

As a result, in particular with a view to the use of the electrode in lamps which have relatively high electrical powers and in particular have electrical powers of greater than 8 kW, a configuration meeting requirements in particular of the core 13 can be made possible which then also meets the legal specifications in terms of the limit values for the radioactivity.

For example, it can also be provided here that the core 13 is designed to be widened in particular in the region of the tip 11 and therefore virtually opens out to the oblique edges of the tip 11 in widened form. Starting from the diameter d1 shown in FIG. 2 in the lower region of the cylindrical shaft 12, in the case of such a configuration an enlargement, in particular a continuous enlargement, of the diameter d1 of the core 13 in the direction towards the tip 11 and in particular in the direction towards the front region of this tip 11, until the peripheral regions of the core 13 open out to the oblique edges of the tip 11 would be formed. From there up to the end length 11, a decrease in the diameter of the core 13 would then again be brought about as a result of the oblique edges of the tip 11, as is shown, for example, in FIG. 2 over the length 14. It could also be provided that this continuous widening and therefore the continuous enlargement of the diameter of the core 13 only begins with the transition from the shaft 12 to the tip 11 and is continued upwards.

In addition to the diameter d1 illustrated in FIG. 2 of the core 13, the total diameter d2 of the cathode 1 is also shown. In the exemplary embodiment, the ratio of the diameter d1 to the diameter d2 has a value of 0.4.

The cathode 1 shown in FIG. 2 is produced by a sintering process, in particular the two material regions and therefore the core 13 and the jacket 14 being joined by the sintering process. The cathode 1 is therefore in the form of a composite electrode and is produced from a tungsten composite material.

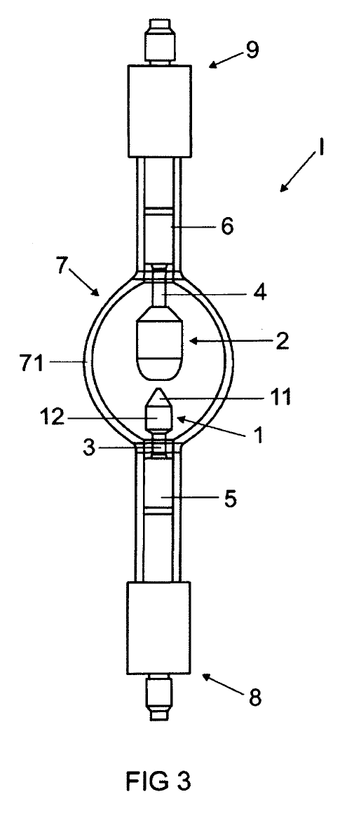

FIG. 3 is a schematic illustration of a high-pressure discharge lamp I, which has a cathode 1 in accordance with the configuration in FIG. 2.

Furthermore, an anode 2 is formed, the cathode 1 being fastened on a holding rod 3, and the anode 2 being fastened on a holding rod 4. These holding rods 3 and 4 then each open out into further fastening elements 5 and 6, respectively, for example quartz rods. These mentioned components of the high-pressure discharge lamp I are arranged in a discharge vessel 7 consisting of quartz glass, in particular the anode 2 and the cathode 1 being arranged in an elliptical discharge bulb 71. The holding rods 3 and 4 are joined to a molybdenum foil (not illustrated), which is fused into the tubular ends of the discharge vessel 7 in a vacuum-tight manner. Furthermore, the high-pressure discharge lamp comprises connection bases 8 and 9.

1. An electrode for a discharge lamp (I) with a cylindrical shaft (12) and a tip (11) which adjoins the cylindrical shaft (12), a first material region (13) forming a core being formed in the longitudinal direction (A) of the electrode (1), and at least regions of the core being surrounded by a second material region (14) forming a jacket.

2. The electrode as claimed in claim 1, characterized in that the first material region (13) extends over the entire length (12, 13) of the shaft (12) and the tip (11).

3. The electrode as claimed in claim 1 or 2, characterized in that the first material region (13) is exposed at a front end of the tip (11) over a predeterminable length (14).

4. The electrode as claimed in claim 1, characterized in that the joint between the first material region (13) and the second material region (14) is formed in a sintering process.

5. The electrode as claimed in claim 1, characterized in that the first material region (13) is formed around the longitudinal axis (A) and is arranged centered in the electrode (1).

6. The electrode as claimed in claim 1, characterized in that the second material region (14) is formed from a tungsten material and is free from thorium.

7. The electrode as claimed in claim 1, characterized in that the first material region (13) is formed from a tungsten material with an additional material, in particular containing thorium.

8. The electrode as claimed in claim 1, characterized in that the ratio of the diameter (d1) of the first material region (13) to the diameter (d2) of the entire electrode (1) is between 0.1 and 0.7.

9. The electrode as claimed in claim 1, characterized in that the electrode (1) has a diameter (d2) of greater than or equal to 12 mm, in particular greater than or equal to 15 mm.

10. A discharge lamp, in particular a high-pressure discharge lamp, which has an electrode (1) as claimed in claim 1.

11. The discharge lamp as claimed in claim 10, which has an electrical power of greater than or equal to 4 kW, in particular greater than or equal to 5 kW.

12. The discharge lamp as claimed in claim 10 or 11, which is in the form of a mercury vapor lamp.

13. The discharge lamp as claimed in claim 12, characterized in that the mercury concentration is greater than or equal to 8 mg/ccm, in particular greater than or equal to 10 mg/ccm.

14. The discharge lamp as claimed in claim 10 or 11, which is in the form of a xenon lamp.

15. The discharge lamp as claimed in claim 14, characterized in that a xenon coldfilling pressure is greater than 6 bar, in particular greater than 8 bar.

16. A method for producing an electrode (1) for a discharge lamp (I), in which the electrode (1) is designed to have a cylindrical shaft (12) and a tip (11) which adjoins the cylindrical shaft (12), a first material region (13) forming a core being formed in the longitudinal direction (A) of the electrode (1), and a second material region (14) forming a jacket being formed around at least regions of the core.

17. The method as claimed in claim 16, characterized in that at least the joint between the material regions (13, 14) is produced by means of a sintering process.
